(19) United States
(12) Patent Application Publication
(10) Pub. No.: US 2024/0168418 A1
(43) Pub. Date: May 23, 2024

(54) FIXING DEVICE AND IMAGE FORMING APPARATUS

(71) Applicant: FUJIFILM Business Innovation Corp., Tokyo (JP)

(72) Inventors: Hideki KUGE, Kanagawa (JP); Hayato NARITA, Kanagawa (JP)

(73) Assignee: FUJIFILM Business Innovation Corp., Tokyo (JP)

(21) Appl. No.: 18/311,271

(22) Filed: May 3, 2023

(30) Foreign Application Priority Data
Nov. 21, 2022 (JP) 2022-186037

(51) Int. Cl. G03G 15/20

(52) U.S. Cl. CPC G03G 15/205; G03G 15/2017

(57) ABSTRACT

A fixing device includes: a heating unit that is disposed on a path for transporting a recording medium by using a transport device for transporting the recording medium and that heats a front surface of the recording medium in a contactless manner; an air-sending device that faces the heating unit and that sends air to a back surface of the recording medium; and a controller that includes a detection unit for detecting an operational state of the air-sending device and that causes the heating unit to operate in a case where the detection unit detects an operation of the air-sending device.

### CROSS-REFERENCE TO RELATED APPLICATIONS

This application is based on and claims priority under 35 USC 119 from Japanese Patent Application No. 2022-186037 filed Nov. 21, 2022.

### BACKGROUND

### (i) Technical Field

The present disclosure relates to a fixing device and an image forming apparatus.

### (ii) Related Art

Japanese Patent No. 6601247 discloses an image forming apparatus that includes an image forming unit that forms a toner image on paper, a resist roller that feeds the paper to the image forming unit with a predetermined transport timing, a fixing unit that heats and presses the paper on which the toner image is formed by the image forming unit at a fixing nip and that fixes the toner image to the paper, an air-sending unit that sends air to the paper from a position downstream of the fixing nip in a direction in which the paper is transported and that separates the paper from a fixing member of the fixing unit, a rotating member that is disposed downstream of the fixing nip in the direction in which the paper is transported and that rotates due to contact with the paper that passes through the fixing nip, a passing paper detection unit that detects the passing paper by detecting rotation of the rotating member, and a controller. The controller increases the amount of the air to be sent from the air-sending unit in the case where a first passing time until the passing paper detection unit detects passing n-th paper after the resist roller feeds the n-th paper (n is an integer of 1 or more) is longer than a maximum passing time that is allowable to an extent that the paper that passes through the fixing nip and that is transported has proper posture. The controller controls the amount of the air to be sent from the air-sending unit depending on a relationship in magnitude between the first passing time and a second passing time in the case where the second passing time until the passing paper detection unit detects passing (n+1)-th paper after the resist roller feeds the (n+1)-th paper is longer than the maximum passing time.

### SUMMARY

Aspects of non-limiting embodiments of the present disclosure relate to a fixing device that includes a heating unit for heating a recording medium with an air-sending device causing the recording medium to be contactless and that inhibits the recording medium from being excessively heated in the case where a transport device stops unlike the case where the heating unit is caused to operate with the air-sending device being stopped.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided a fixing device including a heating unit that is disposed on a path for transporting a recording medium by using a transport device for transporting the recording medium and that heats a front surface of the recording medium in a contactless manner; an air-sending device that faces the heating unit and that sends air to a back surface of the recording medium; and a controller that includes a detection unit for detecting an operational state of the air-sending device and that causes the heating unit to operate in a case where the detection unit detects an operation of the air-sending device.

### BRIEF DESCRIPTION OF THE DRAWINGS

An exemplary embodiment of the present disclosure will be described in detail based on the following figures, wherein:

FIG. 1 schematically illustrates the structure of an image forming apparatus according to the present disclosure;

FIG. 2 schematically illustrates the structure of a toner image forming unit according to the present disclosure;

FIG. 3 schematically illustrates the structure of a fixing unit according to the present disclosure;

FIG. 4 is a perspective view illustrating the structure of a chain gripper according to the present disclosure;

FIG. 5 is a perspective view illustrating the structure of an air-sending device according to the present disclosure;

FIG. 6 is a sectional view of a heat roller and a pressure roller of a fixing device according to the present disclosure;

FIG. 7 is a block diagram illustrating an example of the hardware configuration of a control device according to the present disclosure; and

FIG. 8 illustrates a circuit structure of a controller according to the present disclosure.

### DETAILED DESCRIPTION

An exemplary embodiment of the present disclosure will hereinafter be described by way of example with reference to the figures. In the figures, an arrow H represents the vertical direction and an up-down direction of an apparatus, an arrow W represents the horizontal direction and a width direction of the apparatus, and an arrow D represents a front-rear direction of the apparatus (a depth direction of the apparatus).

### Image Forming Apparatus 10

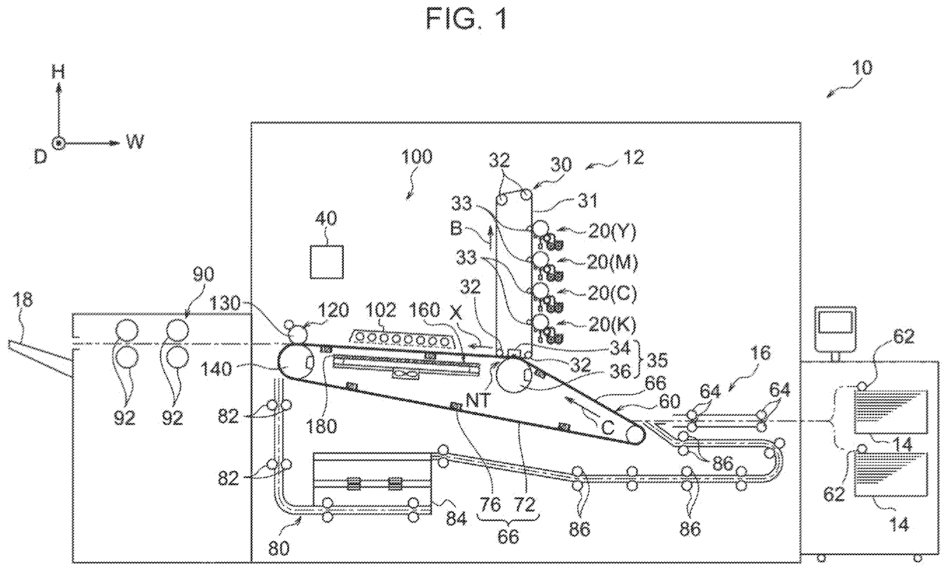

The structure of an image forming apparatus 10 according to the present exemplary embodiment will be described. FIG. 1 schematically illustrates the structure of the image forming apparatus 10 according to the present exemplary embodiment.

The image forming apparatus 10 illustrated in FIG. 1 forms an image on a recording medium that is an example of a sheet material to be transported. More specifically, as illustrated in FIG. 1, the image forming apparatus 10 includes container units 14, a discharge portion 18, an image forming unit 12, a fixing device 100, a cooling portion 90, and a transport device 16. The components (the container units 14, the discharge portion 18, the image forming unit 12, the fixing device 100, the cooling portion 90, and the transport device 16) of the image forming apparatus 10 will now be described.

### Container Units 14

The container units 14 illustrated in FIG. 1 have a function of containing recording media P. The image forming apparatus 10 includes the multiple (for example, two) container units 14. The recording media P are selectively fed from the multiple container units 14. Examples of the recording media P include sheet paper (so-called cut paper) having a predetermined size.

### Discharge Portion 18

Each recording medium P on which an image is formed is discharged onto the discharge portion 18 illustrated in FIG. 1. As for the image forming apparatus 10, the image is heated by the fixing device 100, and subsequently, the recording medium P that is cooled by the cooling portion 90 is discharged onto the discharge portion 18.

### Image Forming Unit 12

The image forming unit 12 illustrated in FIG. 1 is an example of a forming unit that forms a toner image on a recording medium. Specifically, the image forming unit 12 has a function of forming a toner image on the recording medium P by using an electrophotographic system. More specifically, as illustrated in FIG. 1, the image forming unit 12 includes toner image forming units 20 that form toner images and a transfer device 30 that transfers the toner images that are formed by the toner image forming units 20 to the recording medium P.

### Toner Image Forming Units 20

The multiple toner image forming units 20 form the toner images in colors. As for the image forming apparatus 10, the toner image forming units 20 for four colors of yellow (Y), magenta (M), cyan (C), and black (K) in total are provided. Symbols of (Y), (M), (C), and (K) illustrated in FIG. 1 represent components for the respective colors described above.

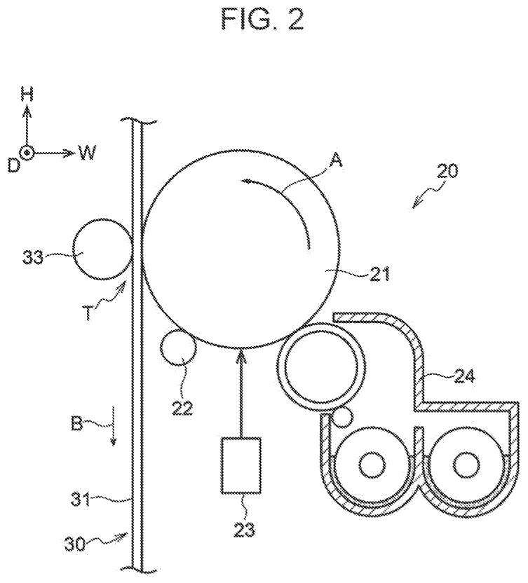

The toner image forming units 20 for the respective colors basically have the same structure except for toner to be used. Specifically, as illustrated in FIG. 2, the toner image forming units 20 for the respective colors include photoconductor drums 21 (photoconductor members) that rotate in the direction of an arrow A in FIG. 2 and chargers 22 that charge the photoconductor drums 21. The toner image forming units 20 for the respective colors also include exposure devices 23 that expose the photoconductor drums 21 charged by the chargers 22 to light and that form electrostatic latent images on the photoconductor drums 21, and developing devices 24 that develop the electrostatic latent images formed on the photoconductor drums 21 by using the exposure devices 23 and that form the toner images.

### Transfer Device 30

The transfer device 30 illustrated in FIG. 1 has a function of first transfer by which the toner images on the photoconductor drums 21 for the respective colors are stacked on an intermediate transfer body and second transfer by which the stacked toner images are transferred to the recording medium P. Specifically, as illustrated in FIG. 1, the transfer device 30 includes a transfer belt 31 that serves as the intermediate transfer body, first transfer rollers 33, and a transfer portion 35.

The first transfer rollers 33 have a function of transferring the toner images that are formed on the photoconductor drums 21 to the transfer belt 31 at first transfer positions T (see FIG. 2) between the photoconductor drums 21 and the first transfer rollers 33.

As illustrated in FIG. 1, the transfer belt 31 has no ends and is wound around multiple rollers 32 so as to have predetermined posture. At least one of the multiple rollers 32 is rotated, and the transfer belt 31 consequently turns in the direction of an arrow B and transports a first-transferred image to a second transfer position NT.

The transfer portion 35 has a function of transferring the toner images that are transferred to the transfer belt 31 to the recording medium P. Specifically, the transfer portion 35 includes a second transfer portion 34 and a facing roller 36.

The facing roller 36 is disposed below the transfer belt 31 so as to face the transfer belt 31. As illustrated in FIG. 1, the second transfer portion 34 is disposed inside the transfer belt 31 such that the transfer belt 31 is between the transfer belt 31 and the facing roller 36. Specifically, the second transfer portion 34 includes a corotron. At the transfer portion 35, the toner images that are transferred to the transfer belt 31 are transferred to the recording medium P that passes through the second transfer position NT by using electrostatic force that is produced due to discharge from the second transfer portion 34.

### Transport Device 16

The transport device 16 illustrated in FIG. 1 transports the recording medium P and includes a transport mechanism 60 and a reverse mechanism 80 as illustrated in FIG. 1. The operation of the transport device 16 to transport the recording medium P is referred to as a transport operation.

### Transport Mechanism 60

The transport mechanism 60 illustrated in FIG. 1 transports the recording medium P. Specifically, the transport mechanism 60 transports the recording medium P that is contained in one of the container units 14 to the image forming unit 12 and causes the recording medium P to pass through the image forming unit 12. The transport mechanism 60 transports the recording medium P from the image forming unit 12 to the fixing device 100 and causes the recording medium P to pass through the fixing device 100. That is, the transport mechanism 60 has a function of transporting the recording medium P on which the image is formed at the fixing device 100.

The transport mechanism 60 transports the recording medium P at the image forming unit 12 and the fixing device 100 with a surface of the recording medium P facing upward. The surface is an image surface on which the image is formed at the image forming unit 12 and is heated at the fixing device 100.

Specifically, as illustrated in FIG. 1, the transport mechanism 60 includes feed rollers 62, multiple transport rollers 64, and a chain gripper 66.

The feed rollers 62 feed the recording media P that are contained in the container units 14. The multiple transport rollers 64 transport each recording medium P that is fed by the feed rollers 62 to the chain gripper 66.

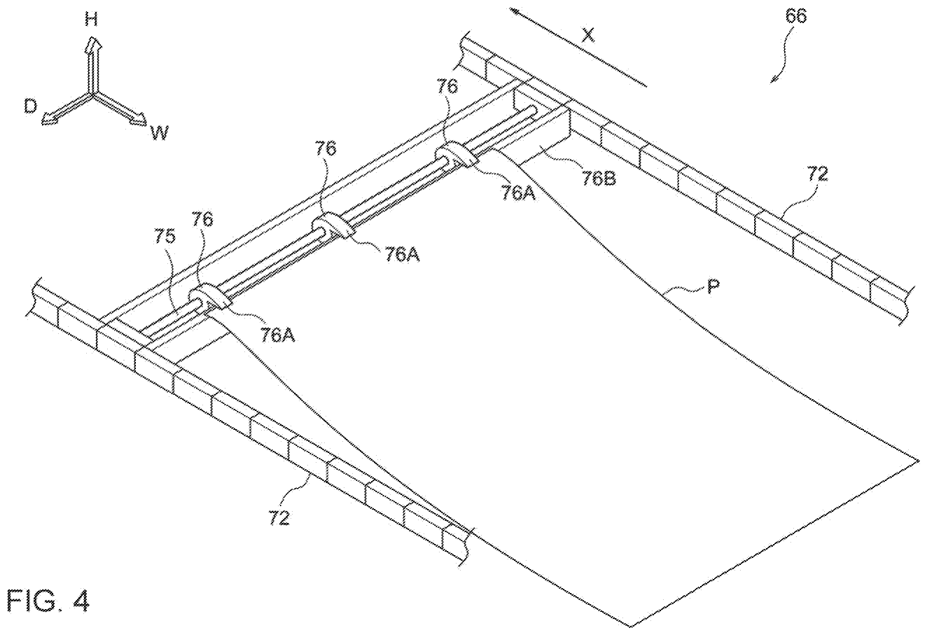

As illustrated in FIG. 4, the chain gripper 66 holds a leading edge portion (that is, a downstream portion in a transport direction) of the recording medium P and transports the recording medium P. Specifically, as illustrated in FIG. 4, the chain gripper 66 includes two chains 72 and grippers 76.

As illustrated in FIG. 1, the two chains 72 are annular. The two chains 72 are arranged at an interval in the front-rear direction (the direction of the arrow D in FIG. 1) of the apparatus (see FIG. 4). As illustrated in FIG. 1, the two chains 72 are wound around two sprockets (not illustrated) that are disposed at an end and another end of the facing roller 36 in an axial direction and two sprockets that are arranged at an interval in the front-rear direction of the apparatus. Any one of the sprockets rotates, and consequently, the chains 72 turn in the direction of an arrow C (see FIG. 1). In the figures, teeth that are formed on the outer circumferences of the sprockets are omitted.

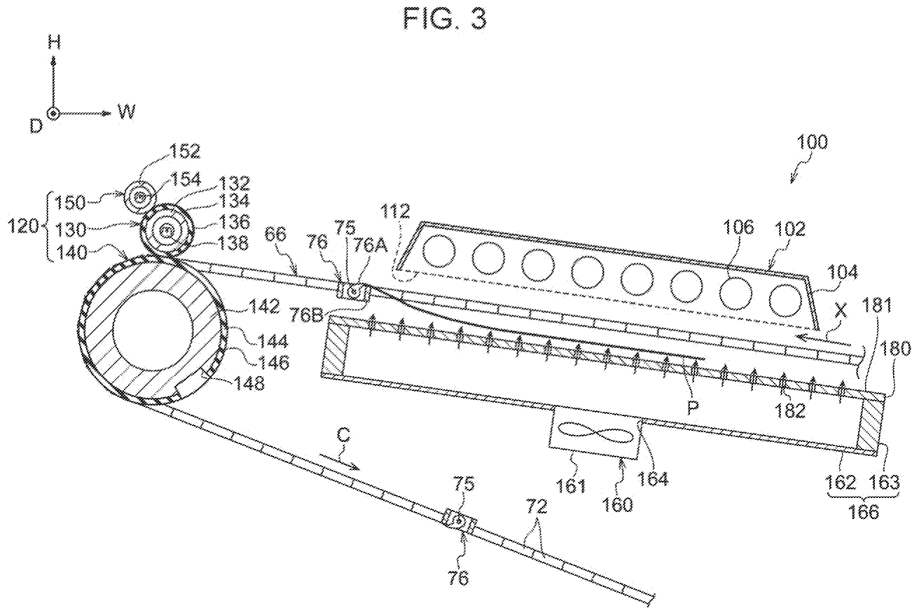

As illustrated in FIG. 4, mount members 75 on which the grippers 76 are mounted extend between the two chains 72 in the front-rear direction of the apparatus. The multiple mount members 75 are fixed to the two chains 72 at a predetermined interval in a circumferential direction (a turn direction) of the chains 72 (see FIG. 1 and FIG. 3). In the figures, the chains 72 are illustrated so as to have block shapes to simplify an illustration for the chains 72.

As illustrated in FIG. 4, the multiple grippers 76 are mounted on the mount members 75 at a predetermined interval in the front-rear direction of the apparatus. The grippers 76 have a function of holding (gripping) the leading edge portion of the recording medium P. Specifically, as illustrated in FIG. 4, each gripper 76 includes a pawl 76A and a pawl base 76B. The gripper 76 holds the recording medium P by interposing the leading edge portion of the recording medium P between the pawl 76A and the pawl base 76B. As for the gripper 76, for example, the pawl 76A is pressed against the pawl base 76B by using, for example, a spring, and the pawl 76A opens or closes with respect to the pawl base 76B by using, for example, a cam action. According to the present exemplary embodiment, the gripper 76 that is disposed downstream of the recording medium P in the transport direction thus holds the leading edge portion of the recording medium P from a position downstream of the recording medium P in the transport direction.

As illustrated in FIG. 3 and FIG. 4, the chain gripper 66 transports the recording medium P with the surface of the recording medium P facing upward in a manner in which the chains 72 turn in the direction of the arrow C with the grippers 76 holding the leading edge portion of the recording medium P. At this time, the chain gripper 66 transports the recording medium P in a state in which a trailing edge portion of the recording medium P is not held. That is, the recording medium P is transported while the trailing edge portion is not restricted but is free. Consequently, the recording medium P passes through the image forming unit 12 and the fixing device 100 with the surface facing upward. A part of a path for transporting the recording medium P at the transport mechanism 60 is illustrated by using a one-dot chain line in FIG. 1.

### Reverse Mechanism 80

The reverse mechanism 80 illustrated in FIG. 1 reverses the front and back of the recording medium P after the image is heated by the fixing device 100. Specifically, as illustrated in FIG. 1, the reverse mechanism 80 includes multiple (for example, two) transport rollers 82, a reverse device 84, multiple (for example, seven) transport rollers 86.

The multiple transport rollers 82 transport the recording medium P that is fed from the fixing device 100 to the reverse device 84. The reverse device 84 reverses the front and back of the recording medium P. The multiple transport rollers 86 transport the recording medium P to the chain gripper 66 after the front and the back are reversed by the reverse device 84. That is, the multiple transport rollers 86 have a function of giving the recording medium P to the chain gripper 66 after the front and the back are reversed.

The reverse mechanism 80 thus gives the recording medium P that passes between a heating unit 102 illustrated in FIG. 3 and a facing surface 181 to the chain gripper 66 after reversing in the up-down direction. The chain gripper 66 transports the recording medium P that is given to a position between the heating unit 102 and the facing surface 181 again via the image forming unit 12 in a state in which the surface on which the toner images are formed faces downward. A part of the path for transporting the recording medium P at the reverse mechanism 80 is illustrated by using a one-dot chain line in FIG. 1.

### Cooling Portion 90

As illustrated in FIG. 1, the cooling portion 90 is disposed downstream of the fixing device 100 described later in the transport direction. The cooling portion 90 includes multiple (for example, two) cooling rollers 92 that are arranged in the transport direction.

The cooling rollers 92 include rollers that are composed of, for example, metal and that are cylindrical. As for each cooling roller 92, refrigerant such as air or water flows in an inner portion thereof, and the recording medium P exchanges heat with the refrigerant and is consequently cooled.

After the toner images are heated by the heating unit 102 described later, the recording medium P is transported by the chain gripper 66 to a fixing unit 120, is interposed between a heat roller 130 and a pressure roller 140, is pressed, and is heated. The recording medium P to which the toner images are fixed is cooled by the cooling rollers 92 of the cooling portion 90 illustrated in FIG. 1 and is subsequently discharged onto the discharge portion 18.

### Fixing Device 100

FIG. 3 schematically illustrates the structure of the fixing device 100. As illustrated in FIG. 1, the fixing device 100 is disposed downstream of the image forming unit 12 in the transport direction. The fixing device 100 includes the fixing unit 120, the heating unit 102, an air-sending device 160, and a controller 40.

### Fixing Unit 120

The fixing unit 120 illustrated in FIG. 3 fixes the image on the recording medium P to the recording medium P and has a function of fixing the toner images to the recording medium P by coming into contact with the recording medium P and heating and pressing the recording medium P. According to the present exemplary embodiment, the recording medium P is preliminarily heated by the fixing device 100, and the fixing unit 120 fixes the recording medium P. The operation of the fixing device 100 to fix the toner images to the recording medium P is referred to as a fixing operation.

As illustrated in FIG. 3, the fixing unit 120 is disposed downstream of the fixing device 100 in the direction in which the recording medium P is transported. Specifically, the fixing unit 120 includes the heat roller 130, the pressure roller 140, and a driven roller 150.

### Heat Roller 130

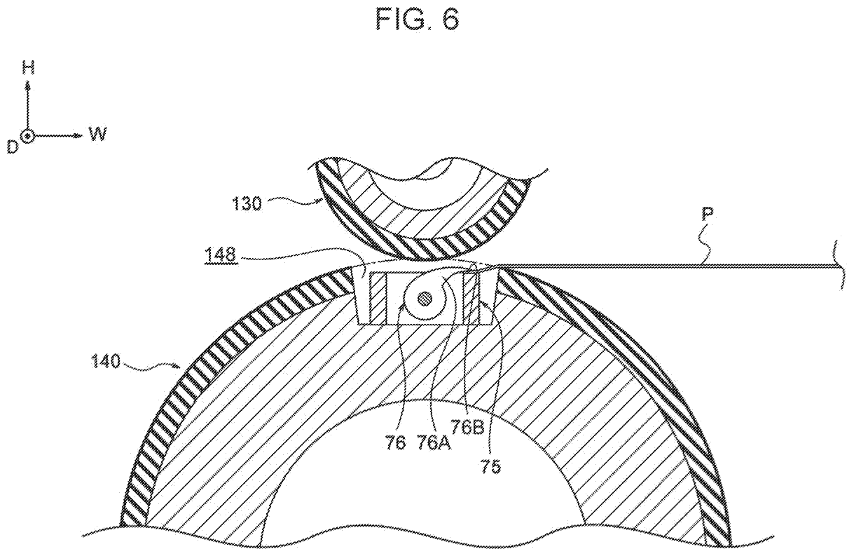

The heat roller 130 illustrated in FIG. 3 and FIG. 6 is disposed downstream of the heating unit 102 described later in the transport direction and has a function of coming into contact with the recording medium P and heating the recording medium P. The heat roller 130 is disposed so as to come into contact with the upper surface of the recording medium P with the front-rear direction of the apparatus coinciding with the axial direction.

The heat roller 130 includes a base material 132 that is cylindrical, a rubber layer 134 that is formed on the outer circumference of the base material 132, a releasing layer 136 that is formed on the outer circumference of the rubber layer 134, and a heater 138 (a heating source) that is contained in the base material 132. For example, the heater 138 includes a single or multiple halogen lamps.

### Driven Roller 150

The driven roller 150 illustrated in FIG. 3 and FIG. 6 is disposed so as to come into contact with a region other than a region of the outer circumferential surface of the heat roller 130 that comes into contact with the recording medium P with the front-rear direction of the apparatus coinciding with the axial direction. The driven roller 150 includes a base material 152 that is cylindrical and a heater 154 (a heating source) that is contained in the base material 152. The driven roller 150 rotates in conjunction with the heat roller 130 and heats the heat roller 130.

### Pressure Roller 140

The pressure roller 140 illustrated in FIG. 3 and FIG. 6 has a function of pressing the recording medium P with the recording medium P interposed between the pressure roller 140 and the heat roller 130. That is, the heat roller 130 and the pressure roller 140 are examples of a pair of rotators that heats the recording medium while rotating with the recording medium interposed therebetween. The pressure roller 140 is disposed below the heat roller 130 with the front-rear direction of the apparatus coinciding with the axial direction.

The pressure roller 140 includes a base material 142 that is cylindrical, a rubber layer 144 that is formed on the outer circumference of the base material 142, and a releasing layer 146 that is formed on the outer circumference of the rubber layer 144.

The length of the circumference of the pressure roller 140 is equal to the interval at which the grippers 76 are disposed on the chains 72. As illustrated in FIG. 3 and FIG. 6, a recessed portion 148 that extends in the front-rear direction of the apparatus is formed on the outer circumferential surface of the pressure roller 140.

In the case where the grippers 76 that hold the leading edge portion of the recording medium P pass between the pressure roller 140 and the heat roller 130, the grippers 76 enter the recessed portion 148.

As for the fixing unit 120, the pressure roller 140 is rotated by a drive unit (not illustrated), the heat roller 130 rotates in conjunction with the pressure roller 140, and the driven roller 150 rotates in conjunction with the heat roller 130.

### Heating Unit 102

The heating unit 102 is disposed on the path for transporting the recording medium P that is transported by the transport mechanism 60 and has a function of heating the front surface in a contactless manner. Specifically, the heating unit 102 heats the upper surface of the recording medium P on which the image is formed by the image forming unit 12 in a contactless manner. It may be thought that the heating unit 102 is a pre-heating device before fixing (heating) with the fixing unit 120. More specifically, the heating unit 102 includes a reflector 104, multiple heaters 106 (heating sources), and a wire net 112. The structure of the air-sending device 160 will be described later.

The reflector 104 has a function of reflecting infrared rays from the heaters 106 downward (that is, toward the recording medium P that is transported by the transport mechanism 60). The reflector 104 has a box shape the bottom of which is opened. The reflector 104 is composed of, for example, a metal plate such as an aluminum plate.

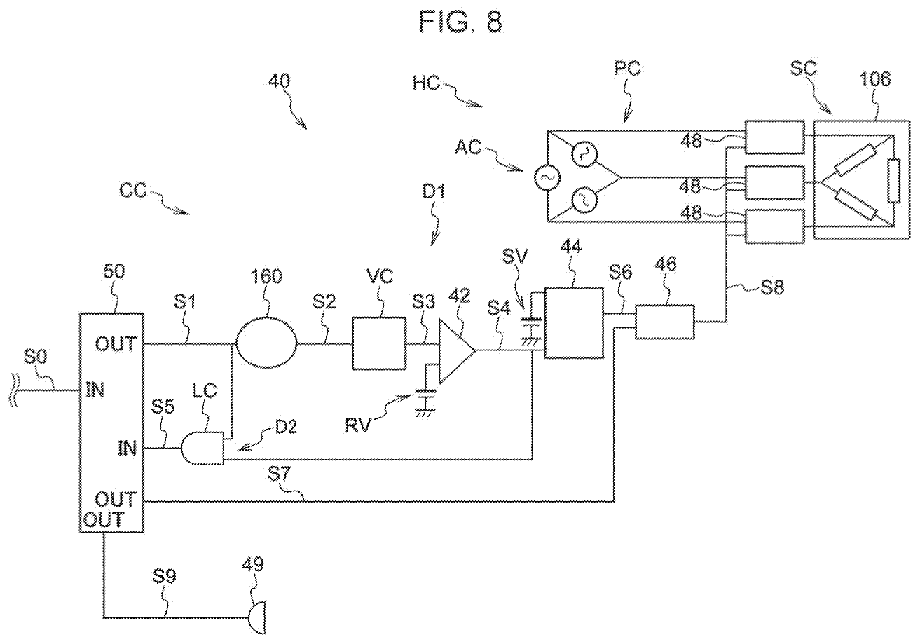

The heaters 106 are infrared heaters that are cylindrical having a length in the width direction of the recording medium P (referred to below as the “paper width direction” in some cases). The heaters 106 are arranged in the transport direction in the reflector 104. The paper width direction coincides with a direction intersecting (specifically, a direction perpendicular to) the transport direction. In the figures, the paper width direction is illustrated as the direction of the arrow D. The heaters 106 are connected to a second circuit SC of relays 48 opposite a first circuit PC that includes a three-phase alternating power supply AC in a power circuit HC described later (also see FIG. 8).

The wire net 112 is disposed in an opening below the reflector 104. Consequently, the wire net 112 separates an inner portion of the reflector 104 from a portion outside the reflector 104. The wire net 112 prevents the recording medium P that is transported by the transport mechanism 60 and the heaters 106 from coming into contact with each other.

### Air-Sending Device 160

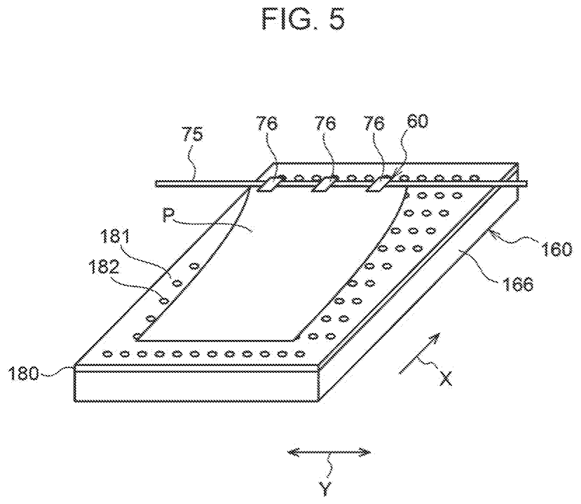

As illustrated in FIG. 3 and FIG. 5, the air-sending device 160 faces the heating unit 102 and sends air toward the back surface of the recording medium P that is transported by the chain gripper 66. Specifically, as illustrated in FIG. 3, the air-sending device 160 is disposed inside the chains 72 (along an inner circumference) and below the path for transporting the recording medium P and includes a fan 161, a device body 166, and an air-sending plate 180. The device body 166 has a box shape the top of which is opened. Specifically, the device body 166 includes a side wall 163 that has a frame shape in a plan view and a bottom wall 162 that has a plate shape. An opening portion 164 is formed in a central portion of the bottom wall 162 in the transport direction and in the front-rear direction of the apparatus. The fan 161 is mounted in the opening portion 164. The fan 161 is rotated and sends air toward an inner portion of the device body 166 via the opening portion 164.

An example of the fan 161 is an axial blower that sends air in an axial direction. The fan 161 may be a centrifugal blower that sends air in a centrifugal direction such as a multi-wing blower (for example, a sirocco fan), provided that the fan is a blower that sends air. The fan 161 is an example of a blower.

The air-sending plate 180 is mounted on an upper edge of the side wall 163 so as to block an upper opening of the device body 166. Consequently, the device body 166 is sealed except for the opening portion 164 and air-sending holes 182 described later.

The air-sending plate 180 has a plate shape and has the facing surface 181 that faces the heating unit 102. The facing surface 181 faces upward and faces the lower surface of the recording medium P that is transported between the heating unit 102 and the air-sending plate 180.

The air-sending plate 180 is composed of a metal plate. The air-sending plate 180 also functions as a reflector that reflects the infrared rays from the heaters 106 upward (toward the recording medium P that is transported by the chain gripper 66).

The air-sending plate 180 has the multiple air-sending holes 182 that extend through the air-sending plate 180 in the thickness direction. That is, the multiple air-sending holes 182 are formed in the facing surface 181 and have openings facing the lower surface of the recording medium P that is transported between the heating unit 102 and the air-sending plate 180.

As illustrated in FIG. 5, the air-sending holes 182 are arranged two-dimensionally (in a matrix shape) in the transport direction and the paper width direction. In FIG. 5, portions of the chain gripper 66 and the air-sending device 160 are simplified.

As for the air-sending device 160, the fan 161 is driven, and consequently, air that enters the device body 166 is sent to the lower surface of the recording medium P that is transported by the chain gripper 66 via the multiple air-sending holes 182 (see FIG. 3). Consequently, the trailing edge portion of the recording medium P the leading edge portion of which is held by the chain gripper 66 is separated upward from the facing surface 181 of the air-sending plate 180 and is not in contact with the facing surface 181 of the air-sending plate 180. That is, the recording medium P is transported in a state in which the recording medium P is not in contact with the facing surface 181 of the air-sending plate 180 by using the chain gripper 66 and the air-sending device 160.

As illustrated in FIG. 3, the air-sending plate 180 is disposed such that the facing surface 181 is at an angle with respect to the horizontal direction (the direction of the arrow W). Specifically, the facing surface 181 extends at an angle with respect to the horizontal direction in a manner in which a downstream portion is higher than an upstream portion in the transport direction (the direction of an arrow X). That is, the facing surface 181 is an inclined surface that has a rising gradient from the upstream portion in the transport direction to the downstream portion. In other words, the recording medium P is transported obliquely with respect to the horizontal direction in a region in which the heating unit 102 and the air-sending device 160 face each other.

Accordingly, as illustrated in FIG. 3, the facing surface 181 extends at an angle when viewed in the paper width direction and in a sectional view in the paper width direction. The facing surface 181 extends in the horizontal direction when viewed in the transport direction and in a sectional view in the transport direction (also see FIG. 5). That is, the facing surface 181 does not obliquely extend when viewed in the transport direction and in a sectional view in the transport direction. The horizontal direction is perpendicular to the vertical direction.

As illustrated in FIG. 4, the facing surface 181 has an angle such that the trailing edge portion of the recording medium P in the transport direction comes into contact when the air-sending device 160 does not send air. Examples of the recording medium P include recording media P having all sizes including the minimum size that are used in the image forming apparatus 10. The angle is defined as the upper limit of the angle of the facing surface 181 with respect to the horizontal direction. In the case where the angle of the facing surface 181 exceeds a predetermined angle, the recording medium P is not in contact with the facing surface 181 when the air-sending device 160 does not send air.

The air-sending holes 182 are formed in a direction perpendicular to the facing surface 181 and extend at an angle with respect to the vertical direction. Specifically, the air-sending holes 182 extend at an angle with respect to the vertical direction toward the upstream portion in the transport direction.

According to the present exemplary embodiment, the air-sending device 160 that includes the fan 161 and the device body 166 in addition to the air-sending plate 180 extends at an angle with respect to the horizontal direction as a whole. Specifically, as for the device body 166, the bottom wall 162 that has a plate shape extends along the air-sending plate 180 and extends at an angle with respect to the horizontal direction. The side wall 163 extends upward in the direction perpendicular to the bottom wall 162 and extends at an angle with respect to the vertical direction. Specifically, the side wall 163 extends at an angle with respect to the vertical direction toward the upstream portion in the transport direction. The fan 161 sends air in a direction (the axial direction) at an angle with respect to the vertical direction. Specifically, the fan 161 sends air in the direction (the axial direction) at an angle with respect to the vertical direction toward the upstream portion in the transport direction.

According to the present exemplary embodiment, the chains 72 extend along the facing surface 181 between the heating unit 102 and the air-sending device 160, and the direction in which the recording medium P is transported above the facing surface 181 is parallel with the facing surface 181. The heaters 106 are arranged in the transport direction as described above, and the heaters 106 are arranged in a direction parallel with the facing surface 181. The direction in which the recording medium P is transported above the facing surface 181 may be at an angle with respect to the facing surface 181. The direction in which the heaters 106 are arranged may be at an angle with respect to the facing surface 181.

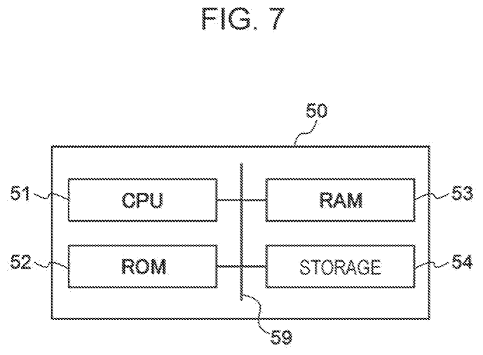

The controller 40 according to the present exemplary embodiment will now be described appropriately with reference to FIG. 7 and FIG. 8.

### Controller 40

The controller 40 is electrically connected to the fixing unit 120, the heating unit 102, and the air-sending device 160 and fulfils various functions for controlling components including the transport device 16 and the image forming unit 12 of the image forming apparatus 10 as described later. The controller 40 according to the present exemplary embodiment includes a control circuit CC that is an example of a detection unit that detects the operational state of the air-sending device 160 and causes the heating unit 102 to operate in the case where the detection unit detects the operation of the air-sending device 160. In other words, the controller 40 includes the detection unit that detects the operational state of the air-sending device 160 and causes the heating unit 102 to stop in the case where the detection unit detects that the air-sending device 160 stops or malfunctions. Specifically, as illustrated in FIG. 8, the controller 40 includes the control circuit CC that includes a control device 50.

### Control Device 50

FIG. 7 is a block diagram illustrating an example of the hardware configuration of the control device 50 according to the present exemplary embodiment.

The control device 50 functions as a computer and includes a central processing unit (CPU) 51 that is an example of a processor, a read only memory (ROM) 52, a random access memory (RAM) 53, and a storage 54 as illustrated in FIG. 7. The control device 50 may include a dedicated processor (such as an application specific integrated circuit (ASIC), a field programmable gate array (FPGA), or a programmable logic device) instead of the structure described above including a general processor.

The CPU 51, the ROM 52, the RAM 53, and the storage 54 are connected to each other by using a bus 59. The CPU 51 collectively control the whole of the control device 50. For example, the ROM 52 stores various kinds of data and various programs including a control program that are used according to the present exemplary embodiment. The RAM 53 is a memory that is used as a work area when the various programs are run. The CPU 51 loads a program that is stored in the ROM 52 into the RAM 53 and runs the program, and consequently, various processes are performed. The control program is an example of an execution program.

For example, the storage 54 includes a hard disk drive (HDD), a solid state drive (SSD), or a flash memory and stores the various programs and the various kinds of data. The control program may be stored in the storage 54.

As for the control device 50, the CPU 51 runs the control program, and consequently, the various functions for controlling the components including the transport device 16 and the image forming unit 12 of the image forming apparatus 10 are fulfilled.

The power circuit HC to which the heaters 106 to be controlled by the controller 40 are connected and the control circuit CC that controls the operations of the heaters 106 according to the present exemplary embodiment will now be described appropriately with reference to FIG. 8.

### Power Circuit HC

As for an electric circuit according to the present exemplary embodiment, as illustrated in, for example, FIG. 8, the first circuit PC that includes the three-phase alternating power supply that is electrically connected is connected to the second circuit SC to which the heaters 106 are connected by using A-A connection. The first circuit and the second circuit are controlled so as to be electrically disconnected or connected by using the relays 48 per phase.

The relays 48 enable the first circuit and the second circuit to be electrically disconnected or connected, and examples thereof include an electromagnetic contactor and a solid state relay (SSR). In the case where the relays 48 electrically connect the first circuit and the second circuit to each other, an alternating voltage is applied to the heaters 106, and consequently, the heaters 106 generate heat. Specific conditions in which the relays 48 operate will be described later.

### Control Circuit CC

As for the control circuit CC of the image forming apparatus 10 according to the present exemplary embodiment, as illustrated in FIG. 8, the control device 50, the air-sending device 160 (a drive motor of the fan 161), a converter VC, a comparator 42, a first controller 44, a second controller 46, an AND circuit LC, and a reporting unit 49 are electrically connected to each other. The control circuit CC is an example of the dedicated circuit according to the present exemplary embodiment and is electrically connected to the relays 48 as described later.

As illustrated in FIG. 8, a binary signal S0 that has a value of “true” that represents the start of a job of an image formation operation or a value of “false” that represents the end of the job is inputted into the control device 50. The binary signal S0 that is inputted has a boolean value that represents “true” or “false”. The image formation operation represents the operation of the image forming apparatus including the transport operation and the fixing operation described above. In the case where the value of the binary signal S0 is “true” (the start of the job), the controller 40 outputs the value of “true” as a binary signal S1. In the case where the value of the binary signal S0 is “false” (the end of the job), the controller 40 outputs the value of “false” as the binary signal S1 after a predetermined time has elapsed. The control device 50 outputs the binary signal S1 to the air-sending device 160 and the AND circuit LC. The binary signal S1 that is outputted has a boolean value that represents “true” or “false”.

The control device 50 acquires the boolean value of a binary signal S5 that is outputted from the AND circuit LC and outputs the boolean value of the binary signal S5 as a binary signal S7 as described later. The control device 50 outputs the binary signal S7 to the second controller 46.

In the case where the value of the binary signal S0 or the value of the binary signal S5 is “true” and the other is “false”, the control device 50 outputs the value of “true” as a binary signal S9 and outputs the value of “false” in the other cases as described later. The control device 50 outputs the binary signal S9 to the reporting unit 49. The binary signal S9 that is outputted is a boolean value that represents “true” or “false”.

In the case where the binary signal S1 that is outputted from the control device 50 is detected, the air-sending device 160 rotates the fan 161. A plus signal S2 that depends on the number of rotation of the fan 161 that rotates is outputted. The air-sending device 160 outputs the plus signal S2 to the converter VC. The plus signal S2 depends on the number of rotation of the drive motor that drives the fan 161.

In the case where the plus signal S2 is received, the converter VC outputs an analog signal S3 that depends on a plus number in the plus signal S2. For example, in the case where the plus number in the plus signal S2 monotonically increases, the analog signal S3 that is outputted monotonically increases. The converter VC outputs the analog signal S3 to a location connected to the comparator 42.

The comparator 42 is electrically connected to a reference voltage source RV in addition to the converter VC described above. The comparator 42 compares the voltage value of the analog signal S3 that is outputted from the converter VC and the voltage value of the reference voltage source RV and outputs the result of comparison as a binary signal S4. The comparator 42 outputs the binary signal S4 to the AND circuit LC and the first controller 44. The binary signal S4 that is outputted is a boolean value that represents “true” or “false”.

In the case where the fan 161 rotates at a number of rotation equal to or more than a number of rotation that is determined during design, the voltage value of the analog signal S3 is set to a value larger than the voltage value of the reference voltage source RV. In the case where the number of rotation of the fan 161 is less than the lower limit that is determined during design, the voltage value of the analog signal S3 is set to a value smaller than the voltage value of the reference voltage source RV. In other words, the voltage value of the reference voltage source RV is set based on the analog signal S3 in the case where the number of rotation of the fan 161 is equal to the lower limit that is determined during design.

According to the present exemplary embodiment, the comparator 42 compares the voltage value of the analog signal S3 that is outputted from the converter VC, based on the plus signal S2 that is outputted from the air-sending device 160 with the voltage value of the reference voltage source RV, and the operational state of the air-sending device 160 is detected. In other words, the converter VC and the comparator 42 are examples of a first detection unit D1 according to the present disclosure. The case where the value of the binary signal S4 is “true” corresponds to an example of the “case where the detection unit detects the operation of the air-sending device”. The case where the value of the binary signal S4 is “false” corresponds to an example of the “case where the detection unit detects that the air-sending device stops or malfunctions”.

The AND circuit LC acquires the binary signal S1 that is outputted from the control device 50 and the binary signal S4 that is outputted from the comparator 42 and outputs the acquired result as the binary signal S5 that is a boolean value that represents “true” or “false”. In the case where both values of the binary signal S1 and the binary signal S4 are “true”, the AND circuit LC outputs the value of “true” and outputs the value of “false” in the other cases. The AND circuit LC outputs the binary signal S5 to the control device 50.

According to the present exemplary embodiment, the AND circuit LC detects the binary signal S1 for driving the air-sending device 160. In other words, the AND circuit LC is an example of a second detection unit D2 according to the present disclosure.

The first controller 44 is, for example, a load switch and is electrically connected to a signal source SV in addition to the comparator 42 described above. The first controller 44 acquires the binary signal S4 that is outputted from the comparator 42 and outputs the voltage value of the signal source SV as the value of “true” of a binary signal S6 in the case where the value of the binary signal S4 is “true”. In the case where the value of the binary signal S4 is “false”, the voltage of the signal source SV is electrically blocked. The first controller 44 outputs the binary signal S6 to the second controller 46. A voltage value that is outputted from the signal source SV is a voltage value for controlling the relays 48 as described later.

The second controller 46 is, for example, a load switch. The second controller 46 acquires the binary signal S7 that is outputted from the control device 50 and outputs the voltage value of the binary signal S6 that is outputted from the first controller 44 as the value of “true” of a binary signal S8 in the case where the value of the binary signal S7 is “true”. In the case where the value of the binary signal S7 is “false”, the voltage of the binary signal S6 is electrically blocked, and the value of “false” of the binary signal S8 is used. The second controller 46 outputs the binary signal S8 to the relays 48.

The relays 48 acquire the binary signal S8 that is outputted from the second controller 46. In the case where the value of the binary signal S8 is “true”, the first circuit PC and the second circuit SC are electrically connected to each other. In the case where the value of the binary signal S8 is “false”, the first circuit PC and the second circuit SC are electrically blocked from each other.

An example of the reporting unit 49 is a component that rumbles such as a buzzer. The boolean value of the binary signal S9 that is outputted from the control device 50 is acquired. The reporting unit 49 does not rumble in the case where the value of the binary signal S9 that is outputted from the control device 50 is “true” and rumbles in the case where the value of the binary signal S9 is “false”. Consequently, the boolean value of the binary signal S9 is reported to a person therearound. In other words, in the case where the controller 40 causes the heating unit 102 to stop, the reporting unit 49 reports the operational state of the heating unit 102. The reporting unit 49 may visually report by using an alarm lamp instead of the buzzer or may report by displaying something at a location on the image forming apparatus 10 for a user input.

The converter VC, the comparator 42, and the AND circuit LC of the control circuit CC may be included as separated parts or may be included as the function of a single integrated circuit (IC) or the control device 50. The comparator 42 compares the voltage value of the analog signal S3 that is outputted from the converter VC and the voltage value of the reference voltage source RV. However, a voltage value that is compared with the voltage value of the analog signal S3 that is outputted from the converter VC may be stored in advance, and the reference voltage source RV may not be included.

The first controller 44 may not be the load switch but may acquire the binary signal S4 that is outputted from the comparator 42 and the voltage signal that is outputted from the signal source SV as in the AND circuit LC described above and may output the value of “true” as the binary signal S6 in the case where both values are “true”. Similarly, the second controller 46 may acquire the binary signal S6 that is outputted from the first controller 44 described above and the binary signal S7 that is outputted from the control device 50 and may output the value of “true” as the binary signal S8 in the case where both values are “true”.

The control device 50 may implement control for causing the transport device 16 to start to be driven in the case where the value of “true” is outputted as the binary signal S1 and for causing the transport device 16 to stop to be driven in the case where the value of “false” is outputted as the binary signal S1, although this is not illustrated in FIG. 8.

### Control Operation

The operation of the control circuit CC depending on the state of the air-sending device 160 according to the present exemplary embodiment will now be described. A “state in which the air-sending device 160 is normal” described later represents a state in which the value of the binary signal S1 is “true”, the fan 161 of the air-sending device 160 is rotated at the number of rotation that is determined during design. A “state in which the air-sending device 160 is abnormal” represents a “state in which the air-sending device 160 is not normal”, for example, a state in which the value of the binary signal S1 is “true”, but the number of rotation of the fan 161 is less than the number of rotation that is determined during design, or the fan 161 is not rotated. The “state in which the air-sending device 160 is abnormal” also represents a “state in which the air-sending device 160 malfunctions”.

Case where Job of Image Formation Operation Starts in State in which Air-Sending Device 160 is Normal

As for the image forming apparatus 10, in the case where the value of the binary signal S0 is “true” (the job of the image formation operation starts), the control device 50 outputs the value of “true” as the binary signal S1 for driving the air-sending device 160.

Subsequently, the air-sending device 160 starts driving the fan 161, based on the binary signal S1. The air-sending device 160 outputs a signal having the plus number that depends on the number of rotation of the fan 161 as the plus signal S2.

Subsequently, the converter VC outputs the voltage value as the analog signal S3, based on the plus number of the plus signal S2.

Subsequently, the comparator 42 compares the voltage value of the analog signal S3 and the voltage value of the reference voltage source RV. In the case where the fan 161 of the air-sending device 160 is normally rotated, the voltage value of the analog signal S3 is larger than the voltage value of the reference voltage source RV, and accordingly, the comparator 42 outputs the value of “true” as the binary signal S4 as described above.

Subsequently, the AND circuit LC outputs the value of “true” as the binary signal S5 because both of the value of the binary signal S1 and the value of the binary signal S4 are “true”.

Subsequently, the first controller 44 outputs the voltage of the signal source SV as the binary signal S6 because the value of the binary signal S4 is “true”.

Subsequently, the controller 40 outputs the value of “true” as the binary signal S7 because the value of the binary signal S5 is “true”. The controller 40 outputs the value of “false” as the binary signal S9 because both of the value of the binary signal S1 and the value of the binary signal S5 are “true”.

Subsequently, the second controller 46 outputs the value of “true” as the binary signal S8 because the value of the binary signal S7 is “true”.

The relays 48 electrically connect the first circuit PC and the second circuit SC to each other because the value of the binary signal S8 is “true”. Consequently, the heaters 106 start generating heat.

In this case, the reporting unit 49 does not rumble because the value of the binary signal S9 is “false”.

As for the fixing device 100 according to the present exemplary embodiment, in the case where the job of the image formation operation starts in the state in which the air-sending device 160 is normal, the fan 161 of the air-sending device 160 is rotated, and subsequently, the relays 48 connect the first circuit PC and the second circuit SC to each other as described above. As illustrated in FIG. 8, the binary signal S6 that is outputted from the first controller 44 is inputted into the second controller 46. That is, as for the control circuit CC according to the present exemplary embodiment, in the case where the first controller 44, the second controller 46, or both detect that the air-sending device 160 stops, the heating unit 102 is stopped.

Case where Job of Image Formation Operation Ends in State in which Air-Sending Device 160 is Normal

As for the image forming apparatus 10, in the case where the value of the binary signal S0 is “false” (the job of the image formation operation ends), the control device 50 first outputs the value of “false” as the binary signal S7. The controller 40 outputs the value of “true” as the binary signal S9 because both of the value of the binary signal S1 and the value of the binary signal S5 are “false”. The control device 50 outputs the value of “false” as the binary signal S1 after a predetermined time has elapsed.

In this case, the second controller 46 outputs the value of “false” as the binary signal S8 because the value of the binary signal S7 is “false”.

The relays 48 electrically disconnect the first circuit PC and the second circuit SC because the value of the binary signal S8 is “false”. Consequently, the heaters 106 stop generating heat.

In the case where the predetermined time has elapsed, and the value of the binary signal S1 that is outputted from the control device 50 is “false”, the air-sending device 160 stops rotating the fan 161. The air-sending device 160 outputs, as the plus signal S2, the value (specifically, 0) of the same plus number as the fan 161 that is rotated. The control device 50 thus causes the air-sending device 160 to stop after the heating unit 102 is stopped when the fixing operation is stopped.

Subsequently, the comparator 42 compares the voltage value of the analog signal S3 and the voltage value of the reference voltage source RV. In the case where the fan 161 of the air-sending device 160 stops rotating, the voltage value of the reference voltage source RV is larger than the voltage value of the analog signal S3, and accordingly, the comparator 42 outputs the value of “false” as the binary signal S4 as described above.

Subsequently, the first controller 44 blocks the voltage of the signal source SV because the value of the binary signal S4 is “false”. That is, the value of “false” is outputted as the binary signal S6.

In this case, the reporting unit 49 does not rumble because the value of the binary signal S9 is “false”.

Case where Job of Image Formation Operation Starts in State in which Air-Sending Device 160 is Abnormal

As for the image forming apparatus 10, in the case where the value of the binary signal S0 is “true” (the job of the image formation operation starts), the control device 50 outputs the value of “true” as the binary signal S1.

Subsequently, the air-sending device 160 causes the fan 161 to start rotating, based on the binary signal S1. In the case where the air-sending device 160 is abnormal, for example, in the case where the number of rotation of the fan 161 is smaller than the number of rotation that is determined during design, the amount of air that is outputted from the air-sending device 160 is smaller than that in the normal state. The air-sending device 160 outputs, as the plus signal S2, the signal of the plus number that depends on the number of rotation of the fan 161.

Subsequently, the converter VC outputs the voltage value as the analog signal S3, based on the plus number of the plus signal S2.

Subsequently, the comparator 42 compares the voltage value of the analog signal S3 and the voltage value of the reference voltage source RV. In the case where the number of rotation of the fan 161 of the air-sending device 160 is smaller than that in the normal state, the voltage value of the reference voltage source RV is larger than the voltage value of the analog signal S3, and accordingly, the comparator 42 outputs the value of “false” as the binary signal S4 as described above.

Subsequently, the AND circuit LC outputs the value of “false” as the binary signal S5 because the value of the binary signal S4 is “false”, even when the value of the binary signal S1 is “true”.

Subsequently, the first controller 44 blocks the voltage of the signal source SV because the value of the binary signal S4 is “false”. That is, the value of “false” is outputted as the binary signal S6. As a result, the value of the binary signal S8 is “false” regardless of the value of the binary signal S7 because the value of the binary signal S6 is “false”, and the heaters 106 are not driven.

In the case where the value of the binary signal S4 is “false”, the control device 50 of the controller 40 outputs the value of “false” as the binary signal S7 because the value of the binary signal S5 is “false”. The controller 40 outputs the value of “true” as the binary signal S9 because the value of the binary signal S0 is “true”, and the value of the binary signal S5 is “false”. The reporting unit 49 rumbles because the value of the binary signal S9 is “true”.

In the case where the value of the binary signal S7 is “false”, the second controller 46 outputs the value of “false” as the binary signal S8. For this reason, for example, even in the case where the first controller 44 mistakenly outputs the value of “true” as the binary signal S6, the second controller 46 outputs the value of “false” as the binary signal S8, and consequently, the heaters 106 are not driven. That is, the second controller 46 functions as a backup of the first controller 44.

As for the fixing device 100 according to the present exemplary embodiment, in the case where the job of the image formation operation starts in the state in which the air-sending device 160 is abnormal, the heaters 106 continue to be electrically blocked from the three-phase alternating power supply AC as described above.

Case where Air-Sending Device 160 is Abnormal after Job of Image Formation Operation Starts

In the case where the air-sending device 160 is abnormal after the job of the image formation operation starts, for example, in the case where the number of rotation of the fan 161 is smaller than the number of rotation that is determined during design, the amount of air that is outputted from the air-sending device 160 is smaller than that in the normal state. The air-sending device 160 outputs, as the plus signal S2, the signal of the plus number that depends on the number of rotation of the fan 161.

Subsequently, the converter VC outputs a voltage value as the analog signal S3, based on the plus number of the plus signal S2.

Subsequently, the comparator 42 compares the voltage value of the analog signal S3 and the voltage value of the reference voltage source RV. In the case where the number of rotation of the fan 161 of the air-sending device 160 is smaller than that in the normal state, the voltage value of the reference voltage source RV is larger than the voltage value of the analog signal S3, and accordingly, the comparator 42 outputs the value of “false” as the binary signal S4 as described above.

Subsequently, the AND circuit LC outputs the value of “false” as the binary signal S5 because the value of the binary signal S4 is “false”, even when the value of the binary signal S1 is “true”.

Subsequently, the first controller 44 blocks the voltage of the signal source SV because the value of the binary signal S4 is “false”. That is, the value of “false” is outputted as the binary signal S6, and accordingly, the value of the binary signal S8 is “false” regardless of the value of the binary signal S7. Consequently, the heaters 106 are not driven.

The controller 40 outputs the value of “false” as the binary signal S7 because the value of the binary signal S5 is “false”. The controller 40 outputs the value of “true” as the binary signal S9 because the value of the binary signal S0 is “true”, and the value of the binary signal S5 is “false”. The reporting unit 49 rumbles because the value of the binary signal S9 is “true”.

In the case where the value of the binary signal S7 is “false”, the second controller 46 outputs the value of “false” as the binary signal S8. For this reason, for example, even in the case where the first controller 44 mistakenly outputs the value of “true” as the binary signal S6, the second controller 46 outputs the value of “false” as the binary signal S8, and consequently, the heaters 106 are not driven. That is, the second controller 46 functions as the backup of the first controller 44.

As for the fixing device 100 according to the present exemplary embodiment, in the case where the air-sending device 160 is abnormal after the job of the image formation operation starts, the heaters 106 stop generating heat as described above. In other words, in the case where is it detected that the air-sending device 160 stops while the heating unit 102 is operating, the controller 40 according to the present exemplary embodiment causes the heating unit 102 to stop.

The actions of the fixing device 100 and the image forming apparatus 10 according to the present exemplary embodiment will now be described.

### Actions

In the case where the heating unit 102 is caused to operate with the air-sending device 160 stopped, there is a possibility that the recording medium P is excessively heated. As for the fixing device 100 according to the present exemplary embodiment, in the case where the controller 40 detects the operation of the air-sending device 160, the heating unit 102 is caused to operate.

In the case where the air-sending device 160 stops while the heating unit 102 is operating, there is a possibility that the recording medium P is excessively heated. As for the fixing device 100 according to the present exemplary embodiment, in the case where the controller 40 detects that the air-sending device 160 stops, the heating unit 102 is stopped.

The controller 40 of the fixing device 100 according to the present exemplary embodiment causes the air-sending device 160 to stop after the operation of the heating unit 102 is stopped when the fixing operation is stopped.

As for the controller 40 of the fixing device 100 according to the present exemplary embodiment, the first detection unit D1 detects the operational state of the air-sending device 160, based on the plus signal S2 that is outputted from the air-sending device 160.

The controller 40 of the fixing device 100 according to the present exemplary embodiment further includes the second detection unit D2 that detects the binary signal S1 for driving the air-sending device 160. In this way, the fixing device 100 according to the present exemplary embodiment may reduce the possibility that the operational state of the air-sending device 160 is mistakenly detected, unlike the case where the controller 40 of the fixing device 100 includes only the first detection unit D1 as the detection unit.

The fixing device 100 according to the present exemplary embodiment includes the reporting unit 49 that reports the operational state of the heating unit 102 in the case where the controller 40 causes the heating unit 102 to stop. For this reason, as for the fixing device 100 according to the present exemplary embodiment, a user is likely to recognize that the heating unit 102 stops, unlike the case where the controller 40 of the fixing device 100 merely causes the heating unit 102 to stop in the case where the malfunction of the air-sending device 160 is detected.

As for the fixing device 100 according to the present exemplary embodiment, the recording medium P is transported obliquely with respect to the horizontal direction in the region in which the heating unit 102 and the air-sending device 160 face each other. For this reason, the fixing device 100 according to the present exemplary embodiment is easy to discharge the recording medium P from the region in which the heating unit 102 and the air-sending device 160 face each other, unlike the case where the recording medium P is transported in the horizontal direction in the region in which the heating unit 102 and the air-sending device 160 face each other.

The fixing device 100 according to the present exemplary embodiment further includes the fixing unit 120 that includes the heat roller 130 and the pressure roller 140 downstream of the heating unit 102 in the direction in which the recording medium P is transported. In this way, the fixing device 100 according to the present exemplary embodiment may heat and transport the recording medium P and fix the toner images to the recording medium P.

The image forming apparatus 10 according to the present exemplary embodiment includes the fixing device 100 according to the present exemplary embodiment.

### Modification

In the above description, the fixing device 100 includes the pair of rotators that heats the recording medium P while rotating with the recording medium P interposed therebetween but is not limited thereto. For example, in the case where the toner images are fixed to the recording medium P by heating the recording medium P at the heating unit 102, the fixing device 100 may not include the pair of rotators.

In the above description, as for the fixing device 100, the recording medium P is transported obliquely with respect to the horizontal direction in the region in which the heating unit 102 and the air-sending device 160 face each other, but this is not a limitation. The transport direction may coincide with the horizontal direction.

In the above description, the fixing device 100 further includes the reporting unit 49 that reports the operational state of the heating unit 102 in the case where the controller 40 causes the heating unit 102 to stop but may not include the reporting unit 49.

In the above description, the control circuit CC includes the first controller 44 and the second controller 46 but may include either the first controller 44 or the second controller 46. That is, only the first controller 44 may be included, and the second controller 46 based on the binary signal S7 may not be included. Only the second controller 46 may be included, and the first controller 44 based on the binary signal S4 may not be included.

In the above description, the controller 40 causes the air-sending device 160 to stop after the heating unit 102 is stopped when the fixing operation is stopped. However, the air-sending device 160 may be stopped earlier than the heating unit 102. For example, the control device 50 outputs the binary signal S1 after the value of the binary signal S0 becomes “true” or “false”, and after a predetermined time has elapsed. Instead, the binary signal S1 may be outputted soon after the value of the binary signal S0 is detected.

In the above description, the controller 40 causes the air-sending device 160 to stop after the heating unit 102 is stopped in the case where the controller 40 detects that the air-sending device 160 stops while the heating unit 102 is operating. However, the air-sending device 160 may be stopped earlier than the heating unit 102.

### Other Modifications

In the above description by way of example, the image forming apparatus 10 has a function of forming the toner images on the recording medium P by using the electrophotographic system but is not limited thereto. For example, in the case where the image forming apparatus 10 is an ink-jet image forming apparatus that forms an image on the recording medium P by using ink, the fixing device 100 is used to fix the image by heating the front surface of the recording medium P to which the ink is applied and vaporizing a solvent in the ink.

In the above description, an example of the recording medium P is sheet paper but is not limited thereto. For example, heat-resistant resin film and metal film are acceptable.

The exemplary embodiment of the present disclosure is described above with reference to the drawings. A person skilled in the art obviously conceives various modifications and applications within the range of technical ideas recited in claims. These are included in the technical range of the present disclosure.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

Exemplary aspects of the present disclosure will be described below.

(((1)))

A fixing device includes a heating unit that is disposed on a path for transporting a recording medium by using a transport device for transporting the recording medium and that heats a front surface of the recording medium in a contactless manner, an air-sending device that faces the heating unit and that sends air to a back surface of the recording medium, and a controller that includes a detection unit for detecting an operational state of the air-sending device and that causes the heating unit to operate in a case where the detection unit detects an operation of the air-sending device.

(((2)))

As for the fixing device in (((1))), the controller causes the heating unit to stop in a case where the controller detects that the air-sending device stops while the heating unit is operating.

(((3)))

A fixing device includes a heating unit that is disposed on a path for transporting a recording medium by using a transport device for transporting the recording medium and that heats a front surface of the recording medium in a contactless manner, an air-sending device that faces the heating unit and that sends air to a back surface of the recording medium, and a controller that includes a detection unit for detecting an operational state of the air-sending device and that causes the heating unit to stop in a case where the detection unit detects that the air-sending device stops.

(((4)))

As for the fixing device in any one of (((1))) to (((3))), the controller causes the air-sending device to stop after the heating unit is stopped when a fixing operation is stopped.

(((5))))

As for the fixing device in any one of (((1))) to (((4))), the detection unit is configured as a dedicated circuit and includes a first detection unit that detects the operational state of the air-sending device, based on a signal that is outputted from the air-sending device.

(((6)))

As for the fixing device in (((5))), the detection unit further includes a second detection unit that determines and detects the operational state of the air-sending device, based on a signal that is outputted from the air-sending device with cooperation of a processor and software, and the controller causes the heating unit to stop in a case where the first detection unit, the second detection unit, or both detect that the air-sending device stops.

(((7)))

The fixing device in any one of (((2))) to (((6))) further includes a reporting unit that reports an operational state of the heating unit in a case where the controller causes the heating unit to stop.

(((8)))

As for the fixing device in any one of (((1))) to (((7))), the air-sending device is disposed below the path for transporting the recording medium, and the recording medium is transported obliquely with respect to a horizontal direction in a region in which the heating unit and the air-sending device face each other.

(((9)))

The fixing device in any one of (((1))) to (((8))) further includes a pair of rotators that is disposed downstream of the heating unit in a direction in which the recording medium is transported and that heats the recording medium while rotating with the recording medium interposed therebetween.

(((10)))

An image forming apparatus includes a forming unit that forms a toner image on the recording medium, the transport device that transports the recording medium on which the toner image is formed, and the fixing device in (((9))) that fixes the toner image to the recording medium.

What is claimed is:

1. A fixing device comprising:
a heating unit that is disposed on a path for transporting a recording medium by using a transport device for transporting the recording medium and that heats a front surface of the recording medium in a contactless manner;
an air-sending device that faces the heating unit and that sends air to a back surface of the recording medium; and
a controller that includes a detection unit for detecting an operational state of the air-sending device and that causes the heating unit to operate in a case where the detection unit detects an operation of the air-sending device.

2. The fixing device according to claim 1,
wherein the controller causes the heating unit to stop in a case where the controller detects that the air-sending device stops while the heating unit is operating.

3. A fixing device comprising:
a heating unit that is disposed on a path for transporting a recording medium by using a transport device for transporting the recording medium and that heats a front surface of the recording medium in a contactless manner;
an air-sending device that faces the heating unit and that sends air to a back surface of the recording medium; and
a controller that includes a detection unit for detecting an operational state of the air-sending device and that causes the heating unit to stop in a case where the detection unit detects that the air-sending device stops.

4. The fixing device according to claim 1,
wherein the controller causes the air-sending device to stop after the heating unit is stopped when a fixing operation is stopped.

5. The fixing device according to claim 3,
wherein the controller causes the air-sending device to stop after the heating unit is stopped when a fixing operation is stopped.

6. The fixing device according to claim 1,
wherein the detection unit is configured as a dedicated circuit and includes a first detection unit that detects the operational state of the air-sending device, based on a signal that is outputted from the air-sending device.

7. The fixing device according to claim 3,
wherein the detection unit is configured as a dedicated circuit and includes a first detection unit that detects the operational state of the air-sending device, based on a signal that is outputted from the air-sending device.

8. The fixing device according to claim 6,
wherein the detection unit further includes a second detection unit that detects a driving signal for driving the air-sending device, and
wherein the controller causes the heating unit to stop regardless of a result of detection of the first detection unit in a case where the second detection unit does not detect the driving signal.

9. The fixing device according to claim 7,
wherein the detection unit further includes a second detection unit that detects a driving signal for driving the air-sending device, and
wherein the controller causes the heating unit to stop regardless of a result of detection of the first detection unit in a case where the second detection unit does not detect the driving signal.

10. The fixing device according to claim 2, further comprising:
a reporting unit that reports an operational state of the heating unit in a case where the controller causes the heating unit to stop.

11. The fixing device according to claim 3, further comprising:
a reporting unit that reports an operational state of the heating unit in a case where the controller causes the heating unit to stop.

12. The fixing device according to claim 1,
wherein the air-sending device is disposed below the path for transporting the recording medium, and
wherein the recording medium is transported obliquely with respect to a horizontal direction in a region in which the heating unit and the air-sending device face each other.

13. The fixing device according to claim 3,
wherein the air-sending device is disposed below the path for transporting the recording medium, and
wherein the recording medium is transported obliquely with respect to a horizontal direction in a region in which the heating unit and the air-sending device face each other.

14. The fixing device according to claim 1, further comprising:
a pair of rotators that is disposed downstream of the heating unit in a direction in which the recording medium is transported and that heats the recording medium while rotating with the recording medium interposed therebetween.

15. The fixing device according to claim 3, further comprising:
a pair of rotators that is disposed downstream of the heating unit in a direction in which the recording medium is transported and that heats the recording medium while rotating with the recording medium interposed therebetween.

16. An image forming apparatus comprising:
a forming unit that forms a toner image on the recording medium;
the transport device that transports the recording medium on which the toner image is formed; and
the fixing device according to claim 14 that fixes the toner image to the recording medium.

17. An image forming apparatus comprising:
a forming unit that forms a toner image on the recording medium;
the transport device that transports the recording medium on which the toner image is formed; and
the fixing device according to claim 15 that fixes the toner image to the recording medium.

18. A fixing device comprising:
heating means for heating a front surface of a recording medium in a contactless manner, the heating means being disposed on a path for transporting the recording medium by using a transport device for transporting the recording medium;
air-sending means for sending air to a back surface of the recording medium, the air-sending means facing the heating means; and
means for detecting an operational state of the air-sending means and for causing the heating means to operate in a case where the means for detecting the operational state detects an operation of the air-sending means.
